(19) United States
(12) Patent Application Publication
(10) Pub. No.: US 2018/0224102 A1
(43) Pub. Date: Aug. 9, 2018

(54) METHODS AND APPARATUS FOR A MULTI-FUNCTIONAL FOLDABLE THIN LIGHT

(71) Applicant: Aixia Bian, Shanghai (CN)

(72) Inventor: Aixia Bian, Shanghai (CN)

(21) Appl. No.: 15/581,863

(22) Filed: Apr. 28, 2017

Related U.S. Application Data
(60) Provisional application No. 62/456,884, filed on Feb. 9, 2017.

(51) Int. Cl. F21V 21/30; F21V 23/04; F21V 21/096; F21V 9/16; F21K 9/64; F21V 21/08

(52) U.S. Cl. CPC F21V 21/30; F21V 23/0414; F21V 21/0965; F21Y 2115/10; F21K 9/64; F21V 21/08; F21V 9/16

(57) ABSTRACT

A portable light includes an elongated housing with a top end and a bottom end. An extension wand is connected to the top end of the elongate housing by a hinge. A forward lighting element is positioned within a forward face of the extension wand and a spotlight is positioned on an end of the extension wand furthest from the hinge. A switch positioned on a front face of the housing. A hook positioned on the bottom end.

### REFERENCE TO RELATED APPLICATION

The present application claims priority to U.S. application Ser. No. 62/456,884, entitled “Methods and Apparatus for a Multi-Functional Foldable Thin Light” and filed on Feb. 9, 2017, the contents of which are incorporated by reference in their entirety.

### FIELD OF THE INVENTION

The present description relates generally to portable devices used for illuminating spaces.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for increasing visibility in hard to reach places like under vehicles. These devices are especially useful in the event of external power loss.

It is an object of this disclosure to provide an improved portable lighting solution that can be carried by a user to provide light in the area they are working as needed.

It is a further object of this disclosure to provide an improved portable lighting solution with a longer lasting power source.

It is a further object of this disclosure to provide an improved portable lighting solution that is dust and water resistant.

### BRIEF DESCRIPTION OF THE DRAWINGS

FIG. 1 is a perspective view of the portable light according to the present invention.

FIG. 2 is a top perspective view of the portable light of FIG. 1.

FIG. 3 is a bottom perspective view of the folded portable light of FIG. 1.

FIG. 4 is a front view of the portable light of FIG. 1.

FIG. 5 is a back view of the portable light of FIG. 1.

FIG. 6 is a left view of another example portable light of FIG. 1.

FIG. 7 is a right view of the portable light of FIG. 1.

FIG. 8 is a top view of the portable light of FIG. 1.

FIG. 9 is a bottom view of the portable light of FIG. 1.

FIG. 10 is a perspective view of the folded portable light of FIG. 1.

FIG. 11 is a perspective view of another example portable light according to the preset invention.

FIG. 12 is a top perspective view of the portable light of FIG. 11.

FIG. 13 is a bottom perspective view of the folded portable light of FIG. 11.

FIG. 14 is a front view of the portable light of FIG. 11.

FIG. 15 is a back view of the portable light of FIG. 11.

FIG. 16 is a left view of another example portable light of FIG. 11.

FIG. 17 is a right view of the portable light of FIG. 11.

FIG. 18 is a top view of the portable light of FIG. 11.

FIG. 19 is a bottom view of the portable light of FIG. 11.

FIG. 20 is a perspective view of the folded portable light of FIG. 11.

### SUMMARY OF THE INVENTION

A portable light includes an elongated housing with a top end and a bottom end. An extension wand is connected to the top end of the elongated housing by a hinge. A forward lighting element is positioned within a forward face of the extension wand and a spotlight is positioned on an end of the extension wand furthest from the hinge. A switch positioned on a front face of the housing. A hook positioned on the bottom end.

A portable light includes an elongated housing with a top end and a bottom end. The elongated housing including a receiving area shaped substantially complementary to an extension wand. The extension wand is connected to the top end of the elongate housing by a hinge. A forward LED lighting element is positioned within a forward face of the extension wand, and a spotlight is positioned on an end of the extension wand furthest from the hinge. A switch is positioned on a front face of the housing. A hook is rotably affixed on the bottom end which is adapted to receive the hook such that the bottom end is substantially flat. A phosphorescent material and a reflector are both positioned around the forward lighting element and the spotlight.

### DETAILED DESCRIPTION

The following description of example methods and apparatus is not intended to limit the scope of the description to the precise form or forms detailed herein. Instead the following description is intended to be illustrative so that others may follow its teachings.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

The terms “light emitting diode” and “LED” are also used in the following description. One of ordinary skill will appreciate that an LED describes a wide variety of two lead semiconductors that emit light by electroluminescence when a voltage differential is applied. LED lights are made in a variety of sizes and typically come in either through-hole or surface mount configurations.

The term “phosphorescence” is also used in the following description. Phosphorescence refers to a mechanism by which a material fluoresces when exposed to radiation. This mechanism is associated with unsuitable energy state transitions in quantum mechanics. A phosphorescence material does not immediately re-emit the radiation it absorbs, but instead absorbed radiation is re-emitted at a lower intensity for up to several hours after the original excitation.

The present application discloses a multi-functional portable thin light. An example foldable light includes an elongated housing with a hinged extension affixed to the upper end of the housing. The extension has a lighting element on its forward facing side and another, a spotlight, on the top end. A switch is positioned on the front side of the housing to engage the lighting elements. A hook is placed on the bottom of the housing to allow the portable light to be located more conveniently to a user.

The example multi-functional folding lighting apparatus may be powered via replaceable or rechargeable batteries. In some instances, the multi-functional folding lighting apparatus includes a charging port into which a connector of a power source can be inserted to supply power to rechargeable batteries of the multi-functional folding lighting apparatus. In other instances, the multi-functional folding lighting apparatus includes a receptacle with conductive contacts into which one or more batteries may be inserted for powering the multi-functional folding lighting apparatus.

In one example situation, when additional lighting is needed as in a power outage or repair task, the user unfolds the extension and activates the portable light by activating the switch. The user selects from the wide light provided by the forward light, which can be used like a lamp, or the more focused light of the spotlight. If the user needs his or her hands, the flashlight may be placed using the magnetic bottom or the rotable hook. After the user is finished, the user can use the charging port to restore power to the device.

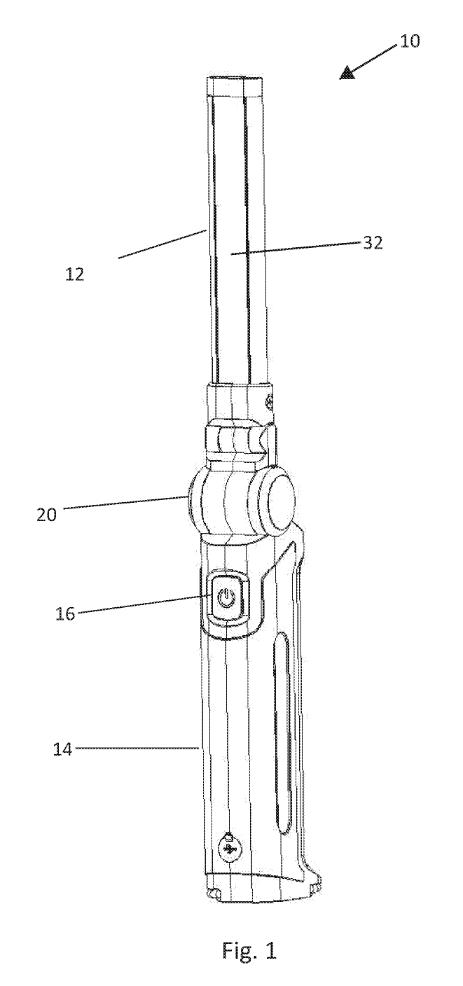

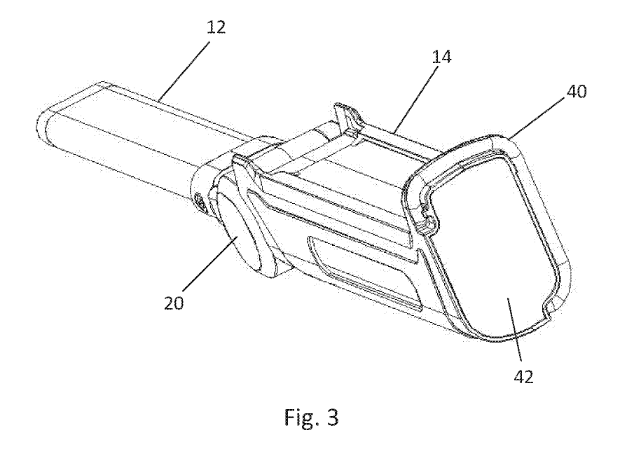

Referring now to FIGS. 1-3, an example of a portable light 10 with a foldable thin light wand or extension 12 is shown. The extension 12 is connected to a base 14 by a hinge 20 as shown in the example portable light 10 in FIG. 1. Rear portions of the extension 12 are made of aluminum to form a rear housing of the light wand for heat dissipation and impact resistance.

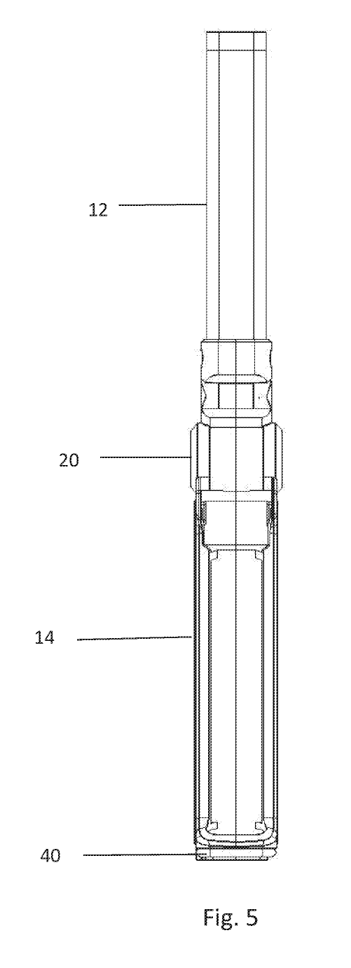

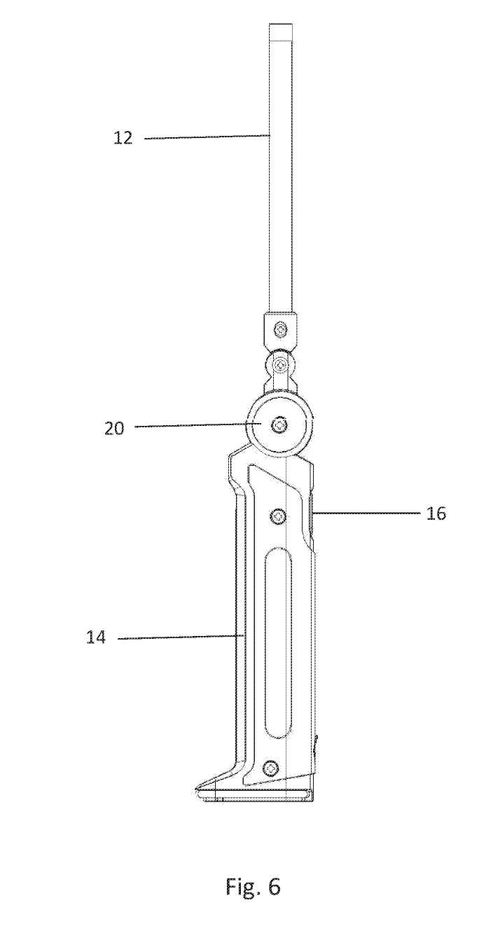

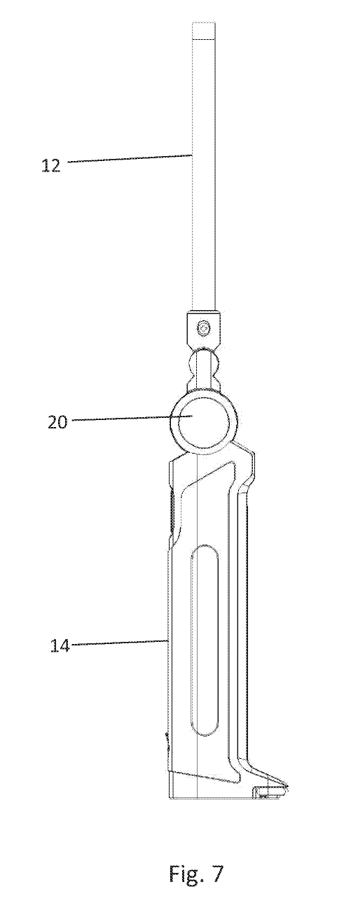

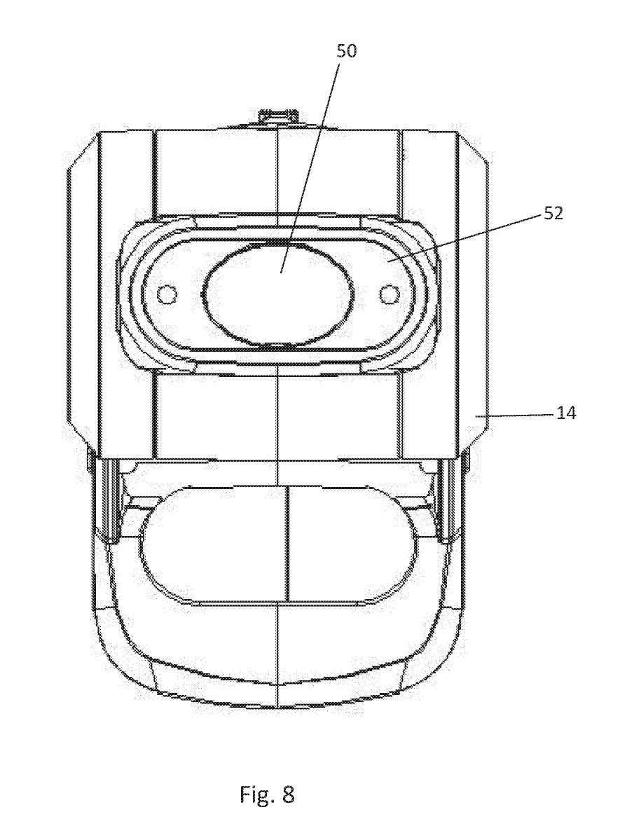

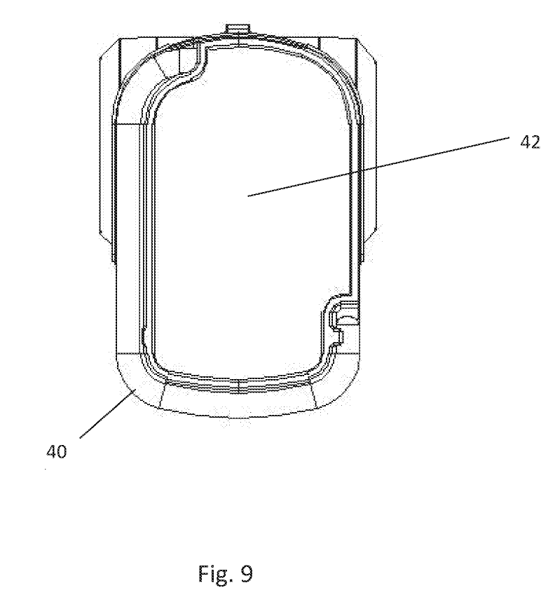

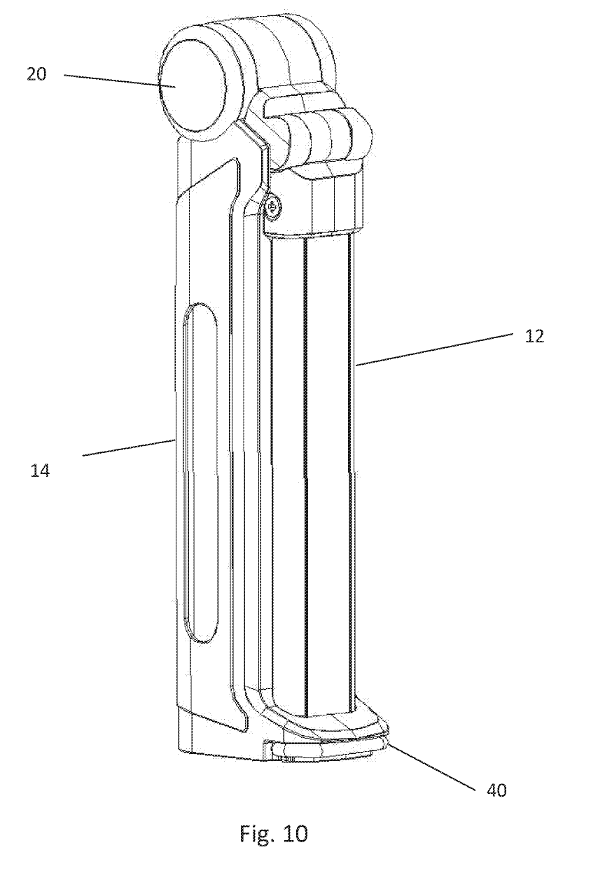

The hinge 20 in the example portable light can rotate a full 180° from the extended position shown in FIGS. 1-9 to the folded position shown in FIG. 10. The extension 12 is equipped with a pivot that allows it to rotate about its vertical center axis to any angle.

The extension 12 supports a high efficiency COB forward LED 32 used to illuminate as shown in FIG. 1. The forward LED 32 is a high color rendition index chips on board LED. A reflector 34 is positioned around the LED 32 to better direct the light away from the device and into the surroundings. It is contemplated that other light emitting technologies can be used in place of LED 32 including techniques such as arc, incandescent, and florescent bulbs. The reflector 34 is also made of a phosphorescence material which can make it easier to find the portable light 10 in the dark, especially if the device is accidentally turned off.

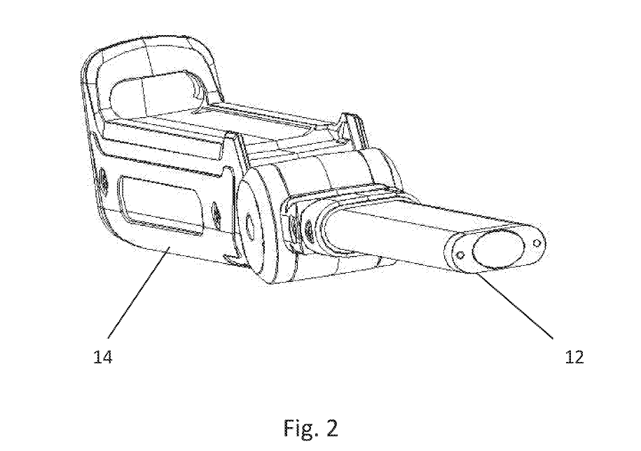

Another LED, a spotlight 50, is positioned at the top of the extension 12 as shown in FIG. 2. The spotlight 50 is also surrounded by a total reflector 52. The top spotlight 50 on the extension 12 uses a hot melt technique in construction to achieve this. The spotlight 50 is a high power surface mounted LED light that can be used as a conventional flashlight when the portable light 10 is extended.

The base portion 14 contains a lithium-ion rechargeable battery to provide power to the rest of the device. The base portion 14 also has a charging indicator 26 built into design and a switch 16 for activating and deactivating the device. The example portable light 10 contains a lithium ion battery, but could also include another cell or series of cells rechargeable, such as those made of nickel cadmium, or alternatively a single use, non-rechargeable battery, such as those made of alkaline. One of ordinary skill in the art will appreciate that internal components in the portable light 10 also contain charging and discharging circuits, heat sinks, and other electronic components.

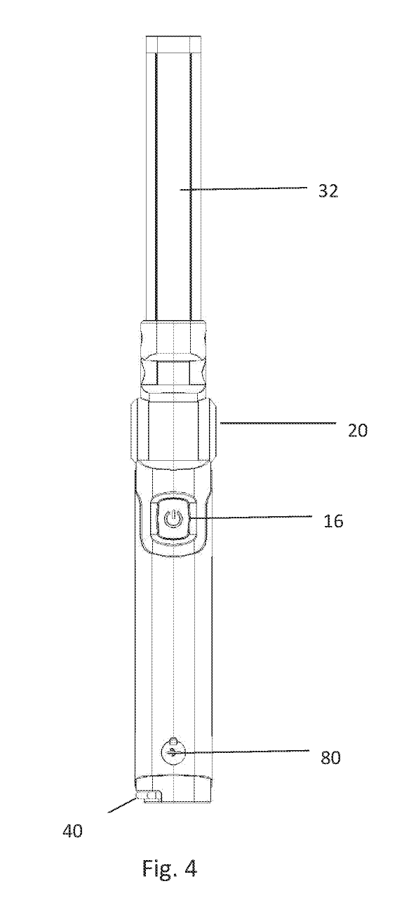

A magnetic bottom 42, as shown in FIG. 4, can support the portable light 10 on a variety of surfaces, including on walls or other non-standard surfaces. A rotable hanging hook 40 is hingedly attached to and can extend out from the base portion 14 in order to hang the device from any perch. For example, the hook 40 could be used to hang the portable light 10 from a car frame, table, or any other location where the user needs hands free light provided.

In use, the extension 12 is a light wand that can pivot +180° and −180° for easy handling and storage. This portable light 10 has an ultra-thin design that pivots and folds flat to allow inspection in the tightest work areas. The strong construction design of base portion 14 allows product to drop safely from up to 1.5 meters. The design of portable light 10 prevents contact and the ingress of dust of more than a de minimis amount that provides no harm to the function of the device. It is also shielded from splashing water such that incidental contact with but not submersion in water.

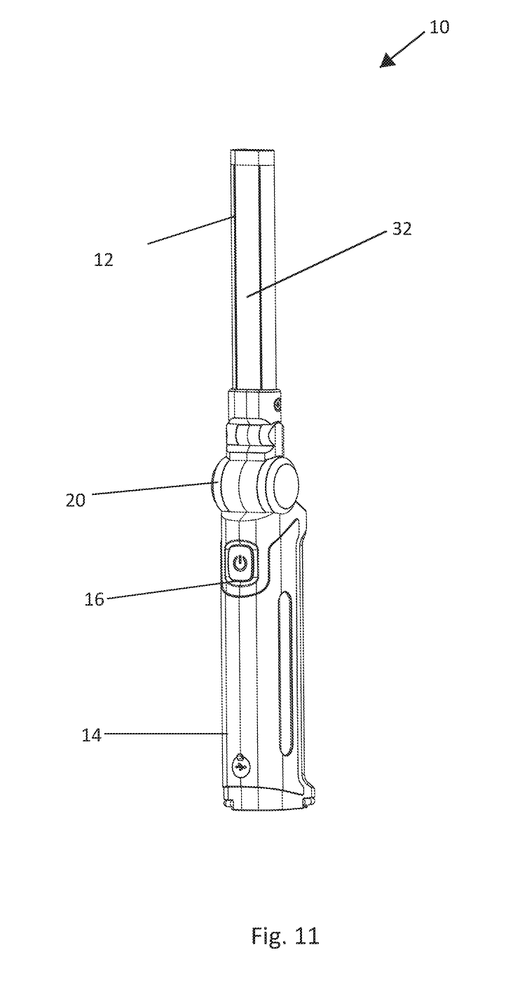

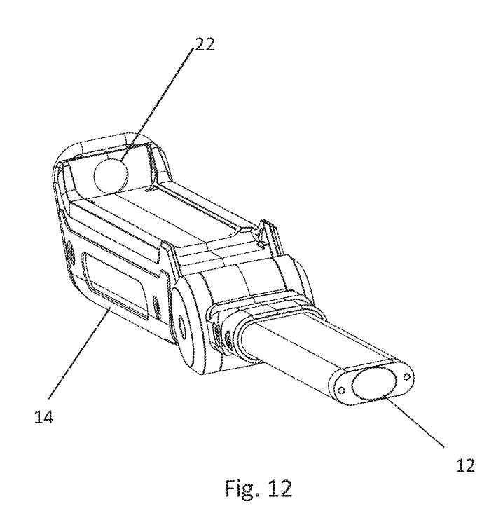

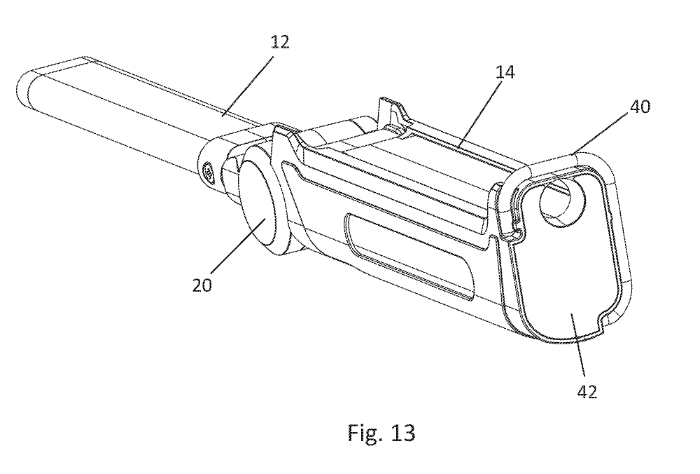

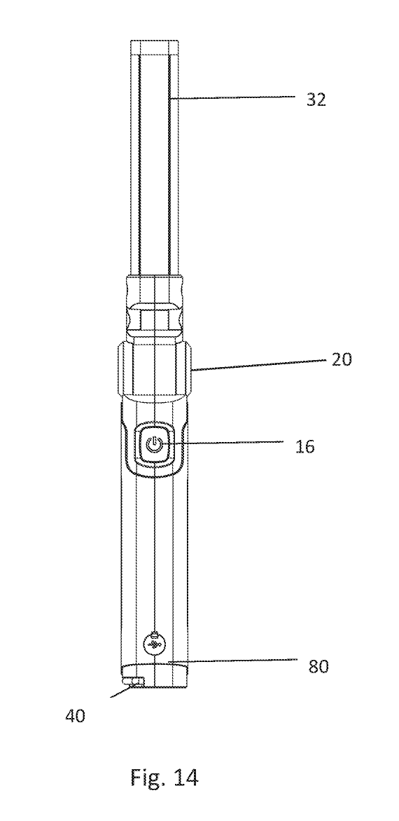

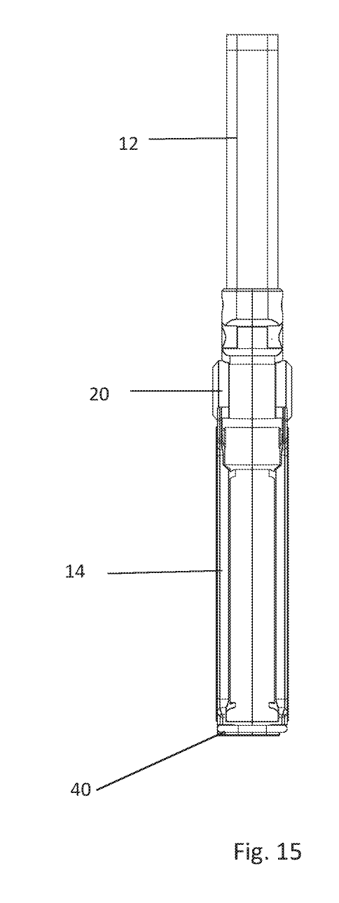

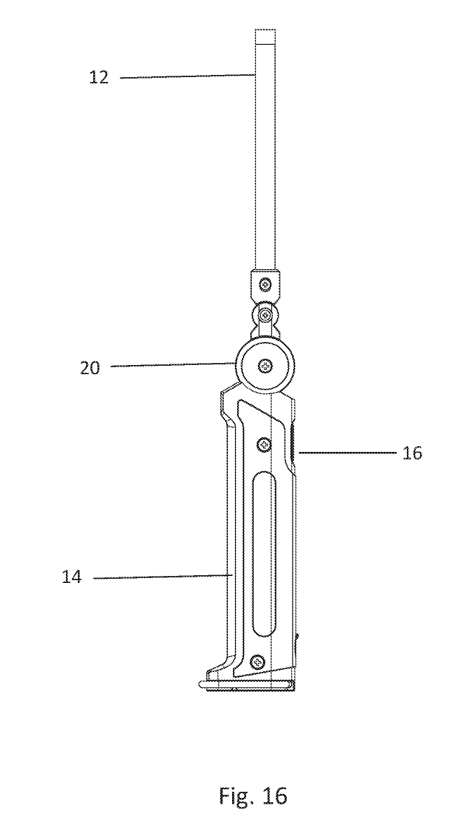

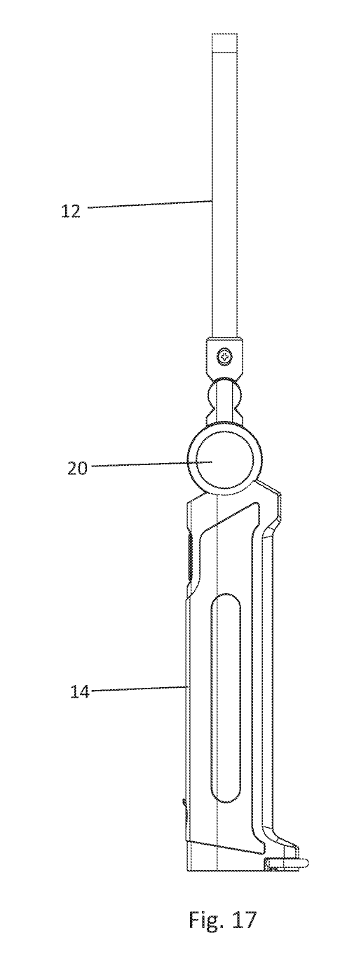

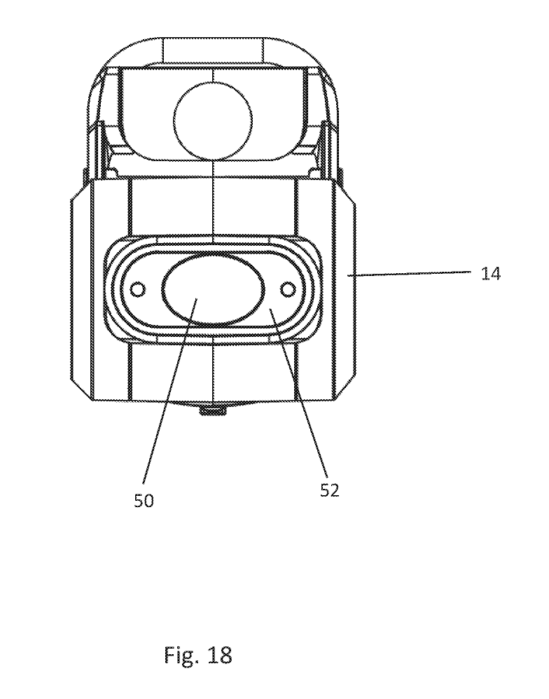

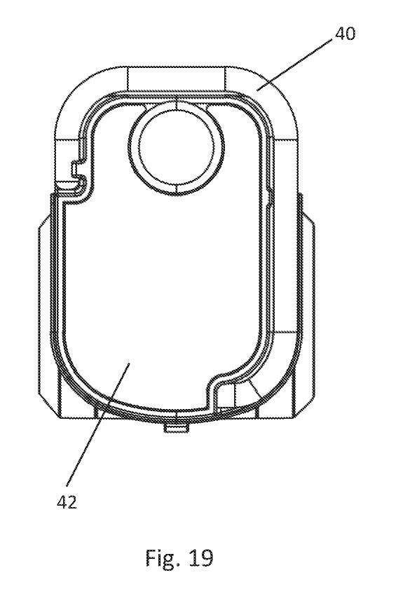

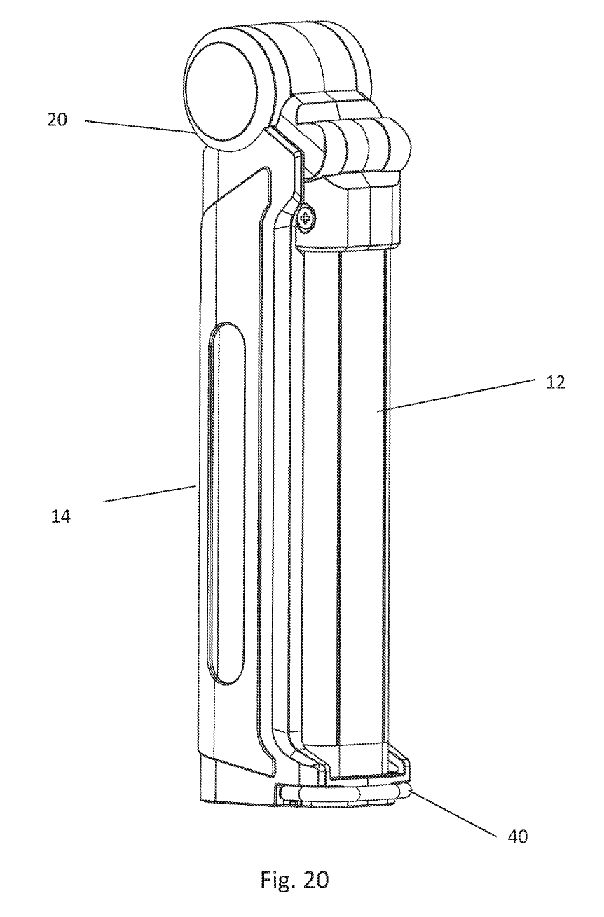

Another example of the portable light is shown in FIGS. 11-20. Unlike the version shown in the earlier figures, this version also includes an aperture 22. In the closed position, when the extension 12 lays against the base portion 14, the aperture 22 is placed in line with the spotlight 50. The alignment of the aperture 22 with the spotlight 50 allows the portable light to function in a way similar to that of a conventional flashlight in the closed position. The aperture 22 can also be used as an additional means of affixing the light to various locations. The aperture 22 can be used, for example, to clip a carabineer to the light.

In the foregoing description, the terms “top,” “bottom,” “front,” “back,” “rear,” “right,” and “left” have been used. These terms are used to give a relative position and orientation to the disclosure. These terms should not be read to impart an absolute position or orientation relative to any other item or location.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

I claim:

1. A portable light comprising:
an elongated housing with a top end and a bottom end;
an extension wand connected to the top end of the elongated housing by a hinge, a forward lighting element positioned within a forward face of the extension wand and a spotlight positioned on an end of the extension wand furthest from the hinge;
a switch positioned on a front face of the housing; and
a hook positioned on the bottom end.

2. The portable light of claim 1 where the elongated housing further comprises a receiving area shaped substantially complementary to the extension wand and further adapted to cooperatively receive the extension wand.

3. The portable light of claim 1 further comprising a magnetic surface at the bottom end of the extended housing.

4. The portable light of claim 1 further comprising a phosphorescent material placed proximate to either the forward lighting element or the spotlight.

5. The portable light of claim 4 wherein the phosphorescent material is formed substantially around either the forward lighting element or the spotlight.

6. The portable light of claim 1 further comprising a reflector positioned around either the forward lighting element or the spotlight.

7. The portable light of claim 1 wherein repeated activation of the switch cycles through modes of function of the device where either the forward lighting element or the spotlight are on, both are on, and both are off.

8. The portable light of claim 1 wherein the hinge and extension wand can rotate 180° in either direction.

9. The portable light of claim 7 wherein the housing is adapted to allow the extension wand to sit substantially flat against the housing.

10. The portable light of claim 1 wherein the forward lighting element or the spotlight is a high power SMD LED.

11. The portable light of claim 1 wherein the hook is rotably affixed to the bottom end of the housing.

12. The portable light of claim 11 wherein the bottom end of is adapted to receive the hook such that the bottom end is substantially flat.

13. A portable light comprising:
an elongated housing with a top end and a bottom end, the elongated housing including a receiving area shaped substantially complementary to an extension wand;
the extension wand is connected to the top end of the elongated housing by a hinge, a forward LED lighting element positioned within a forward face of the extension wand and a spotlight positioned on an end of the extension wand furthest from the hinge;
a switch positioned on a front face of the housing; and
a hook rotably affixed on the bottom end, wherein the bottom end of is adapted to receive the hook such that the bottom end is substantially flat;
wherein a phosphorescent material and a reflector are both positioned around the forward lighting element and the spotlight.
